(19) United States
(12) Patent Application Publication
(10) Pub. No.: US 2026/0360343 A1
(43) Pub. Date: Nov. 12, 2026

(54) DYNAMIC EFFECTS KARAOKE

(71) Applicant: CERENCE OPERATING COMPANY, Burlington, MA (US)

(72) Inventors: Philipp Bulling, Burlington, MA (US); Stefan Richardt, Ulm (DE); Tim Haulick, Ulm (DE); Timo Matheja, Burlington, MA (US); Markus Buck, Ulm (DE)

(21) Appl. No.: 19/123,906

(22) PCT Filed: Nov. 2, 2023
(86) PCT No.: PCT/US2023/036670

§ 371 Date: Apr. 24, 2025

Related U.S. Application Data
(60) Provisional application No. 63/425,428, filed on Nov. 15, 2022.

(51) Int. Cl. G10H 1/36; G10K 11/178

(52) U.S. Cl. CPC G10H 1/366; G10K 11/17823; G10H 2210/056

(57) ABSTRACT

A computer-implemented Karaoke system, which may be deployed in a vehicle for use by a driver and/or one or more passengers of the vehicle, adjusts relevant settings depending on the properties of the song, for instance as automatically determined by analysis of the audio signal of a song. In some examples, the system may dynamically remix original vocals or user-provided vocals depending on whether the user is singing.

### CROSS-REFERENCE TO RELATED APPLICATIONS

This application claims the benefit of U.S. Provisional Application No. 63/425,428, filed Nov. 15, 2022, the content of which is incorporated herein.

### BACKGROUND

This invention relates to dynamically processing vocal accompaniment of recorded audio content, and in particular to dynamic effects in a Karaoke system.

Conventional “Karaoke” is a type of interactive entertainment usually offered in clubs and bars, where people sing along to recorded music using a microphone. The music is typically an instrumental version of a well-known popular song. Lyrics are usually displayed on a video screen, along with a moving symbol, changing color, or music video images, to guide the singer. Hardware, and some software (e.g., smartphone app), systems include features such as digital signal processing of a user's voice, for example, to add reverberation and to tune their voice to a specified musical key.

Karaoke systems usually come with an electro-acoustic system with microphone, amplifier, and loudspeaker to reinforce the singer's voice. The Karaoke set plays back a special music track where the audio track of the lead singer is missing. The music itself incorporates a lot of audio effects that have been applied during music production. Therefore, also for the voice of the Karaoke singer some audio effects should be applied by the electro-acoustic system such that the music and the Karaoke contribution fit well together in terms of style.

Karaoke sets therefore usually offer various audio effects that can be selected to enrich the singer's voice. For example, equalizers to emphasize relevant frequencies, compressors to reduce loudness variations, reverberation effects with adjustable reverberation time, delays that add decaying echoes of the voice to the output signal, chorus effects to create the impression of multiple singers singing simultaneously, exciters that add brightness to the voice, pitch shifting or vocal harmonizer effects, and many more.

In-vehicle Karaoke, sometimes referred to as “Carpool Karaoke” (referencing a television show starring James Corden), is a type of Karaoke that may be performed by passengers or the driver of a vehicle. Commercial products are available that support features such as capturing vocals from multiple passengers in a vehicle and reducing feedback sound from the vehicle's speakers.

### SUMMARY

Conventional Karaoke systems require adjusting of individual effects for different types of songs. For example, it may be desirable to have a longer reverberation time for a slow song as compared to the reverberation time that may be best for a song with faster rhythms. Similarly, it may be preferable to match the delay time between two consecutive echoes to the tempo of a song. Depending on the instrumentation of the song, it might be necessary to adjust the equalizer to embed the voice into the mix. Ballads or emotional songs might require loudness variations, whereas in energetic songs the dynamic of the voice should be compressed. Additionally, these potential adjustments may also vary within a song related to the current part of the song, different effects might be chosen for the refrain compared to the verse. Karaoke systems available today require that these effects need to be adjusted manually. It would be desirable to have a more automated system that assists in adjusting the relevant parameters automatically without necessarily requiring any manual adjustment.

A vehicle environment poses a number of challenges for a Karaoke system, including the relatively “dead” acoustic environment, and the presence of road and other ambient noise, which can be significant in volume and varying, for example, by speed and road type, and can include outside noises such as sirens and construction jack-hammers. Very generally, one or more systems and methods described in this document dynamically changes features of the processing for a user's (i.e., a singer's) input according to characteristics of the audio being sung and/or the acoustic environment in which the user is singing. An advantage of system processing can include an improved user experience (e.g., it is more fun or engaging to use the system) and/or a higher quality audio output (e.g., the result of combining the presented audio and the captured audio has more desirable and/or pleasant characteristics).

In this document, the word “Karaoke” should be interpreted broadly to include any situation in which a system is configured to present an acoustic signal to one or more users, and to capture audio produced by the one or more users during the presentation of the acoustic signal. For the sake of discussion, the acoustic signal that is presented may be referred to below as a “song” without any connotation that the audio signal includes sung or spoken words, or that it includes music intended to be sung along to; and the captured audio (or their processed versions) may be referred to as the user's “vocals” without any connotation that the captured audio necessarily includes lyrics or other spoken or sung words. Finally, there is no requirement that text of a song or the like is presented to a user of a Karaoke system, or that the captured audio is necessarily presented along with the song to a user.

In an aspect, a computer-implemented Karaoke system adjusts relevant settings depending on the properties of the song, for instance as automatically determined by analysis of the audio signal of a song.

In some embodiments, the Karaoke system is deployed for use in a vehicle, for example, for use by a driver and/or one or more passengers of the vehicle. Multiple microphones may be used, for instance, as distributed speaker-dedicated microphones or in close distance in an array configuration processing a beamformer to focus into specific directions where passengers are speaking. Using multiple microphones, the system may also be able detect how many singers are participating in the Karaoke and in which seat in the car they are sitting. The system might then assign different audio effects, for instance, automatic gain control (AGC) to the individual contributors to ensure consistent levels for the individual singing contributions. For example, a singer on the backseat may be assigned with effects typical for background singers. Maybe also some pitch shifting, such as transposing by one octave, can be applied.

In some embodiments, a song selected is analyzed with respect to basic properties such as speed, loudness dynamics, music style, genre, song structure, etc. Depending on these properties a set of effects is chosen and configured. In some embodiments, some of this information may be already available from the database, e.g., the pitch frequency, the tempo, and polyphony may be available from a MIDI file, information on the genre may be available from the database, and therefore no automatic extraction is needed. In some embodiments, a predefined set of audio effects for a song can be prepared by manual tuning, for example, with a user manual tuning for a favorite song, thereby ensuring an optimal (i.e., most desirable) set of audio effects.

In some embodiments, audio effects may change within one song. For instance, different effect settings might be used for chorus and for verse. The determination of the chorus versus verse may be determined automatically, for example, based on repetition of the chorus. As another instance, different effects may be applied at the end of a song as compared to during the song such as introducing a delay effect at the end of a break in vocals without having the delay effect active continuously, which may be disturbing to the singer.

In some embodiments, the audio effects may be adjusted depending on the background noise. For instance, in high noise situations a higher playback gain, and less reverb may be applied. The background noise can be estimated using the same microphone that is used for Karaoke. Such audio effects may be particularly useful for in-vehicle applications where background noise may be substantial and may vary over time. In some embodiments, the microphone(s) and loudspeaker(s) are not necessarily dedicated to Karaoke, for example, being integrated into an audio entertainment system, a hand-free telephony system, and/or a voice assistant system.

In some embodiments, Karaoke system is configured to interact with other Karaoke systems at other locations, thereby forming a distributed Karaoke system enabling users to participate from multiple locations. For in-vehicle Karaoke systems, the vehicles are connected via a mobile communication system, and the drivers and/or passengers in multiple vehicles can provide vocals for one song, for example, by the systems synchronizing or otherwise coordinating playback of the song and the vocals. The singers' voices are not only played back in the local vehicle but also transmitted to the other vehicle to be added to the Karaoke sound track together with the voice on the far-end. The audio playback in both vehicles may be synchronized as well as possible, and remaining mismatch in synchronization (which may not be avoidable) is considered in the reverberation effect. The voice from the far-end car can be processed with different audio effects to put it as a chorus on the surround loudspeaker. For example, the music in two vehicles A and B starts at the same time and is synchronized. The singers' voices from car A then are fed to the effects section of the far end car B where, for instance, surround effects, reverb etc. is generated out of it. The same will be done for the singers' voices in car B transmitted to car A.

In one aspect, in general a method for dynamic audio modification of user input for presentation with playback of a source song includes processing a microphone signal to produce an audio voice signal representing a user input.

Parameter values for one or more audio modification approaches are determined based on characteristics of the source song, and audio voice signal is processed with the audio modification approaches configured according to the determined parameter values to produce an enhanced vocal signal. An advantage of such modification is that the user does not have to readjust the parameters manually when changing songs, which may be particularly advantageous in situations in which the user is occupied with another task, for instance, being occupied with driving a vehicle.

The enhanced vocal signal and the source song are combined to produce an audio driving signal, and the audio driving signal is provided for acoustic presentation to the user.

An acoustic signal is acquired at a microphone to produce the microphone signal, The acoustic signal includes at least the user's voice and the acoustic presentation of the audio driving signal. Processing the microphone signal may then include removing the acoustic presentation of the audio driving signal based on an adaptation that makes use of at least one of a reference of the audio driving signal and source song. The acoustic signal may include ambient noise and the processing of the microphone signal comprises noise reduction.

The audio modification approaches include one or more of reverberation, echo, excitation, and pitch modification processing.

Characteristics of the source song includes one or more of a genre, tempo, musical key, and time signature.

Determining the parameter values includes determining time varying parameter values that vary during a song. Such time varying may be advantageous because different parts of a song, for instant, a chorus and a stanza, may warrant different processing.

An original vocals signal and a vocal-removed song signal may be determined to correspond to an original source song, and combining the enhanced vocal signal and the source song includes combining the enhanced vocal signal and the vocal-removed song signal.

The audio voice signal is processed to determine a voice level of a user input. The voice level may represent a presence or absence of voice, or may represent a volume or energy of voice.

The voice signal is determined to have a presence of the user input during a first period and an absence of the user input during a second period.

An audio driving signal is formed, including combining the audio voice signal and the vocal-removed song signal to produce an audio driving signal during the first period.

The audio driving signal is formed, including combining the original vocals signal and the vocal-removed song signal to produce the audio driving signal during the second period. Such presentation of the original vocals may be advantageous when the user forgets the words, and begins to sing at a lower level.

Forming the audio driving signal further includes, during the first interval, combining the original vocals signal at an attenuated level that is based on the determined voice level (e.g., based on history or a time filtering of the voice level). Such attenuated presentation of the original vocals may be advantageous when the user may not be sure of the words, and begins to sing at a lower level.

Determining the original vocals signal and the vocal-removed song signal includes receiving said vocals signal and said vocal-removed signal prior to the playback of the source song.

Determining the original vocal signal and the vocal-removed song signal includes processing the original source song to demix vocal and vocal-removed components of the original source song.

Voice is detected in the microphone signal, and during a period when voice is not detected in the microphone signal providing a signal corresponding to the original source song, including providing at least some of the original vocals signal, for acoustic presentation to the user.

The microphone signal is acquired in a cabin of a first vehicle, and the audio driving signal is presented in the cabin of the first vehicle.

A remote vocal signal is received from a second vehicle, and the enhanced vocal signal, the remote vocal signal, and the source song are combined to produce the audio driving signal.

The enhanced vocal signal is provided for presentation in the second vehicle.

Presentation of the song in the first vehicle and the second vehicle are synchronized.

Determining the parameter values for one or more audio modification approaches based on characteristics of the source song is performed at the first vehicle during presentation of the song to the user.

Determining the parameter values for one or more audio modification approaches based on characteristics of the source song is performed prior to presentation of the song to the user.

In another aspect, in general, a non-transitory machine-readable medium has instructions stored on it. The instructions, when executed by a processor, cause the processor to perform all the steps of any one of the methods set forth above.

In another aspect, in general, an audio processing system includes a processor configured to perform all the steps of any one of the methods set forth above. The audio processing system of may comprise an in-vehicle audio processing system. The audio processing system may be integrated into at least one of an audio entertainment system, a hand-free telephony system, or a voice assistant system.

Other features and advantages of the invention are apparent from the following description, and from the claims.

### BRIEF DESCRIPTION OF THE DRAWINGS

FIG. 1 is a schematic diagram of a vehicle-based Karaoke system.

FIG. 2 is a schematic block diagram of an audio processing system.

FIG. 3 is a schematic block diagram of a voice processing module.

FIG. 4 is a schematic block diagram of an audio processing system with dynamic remixing.

### DETAILED DESCRIPTION

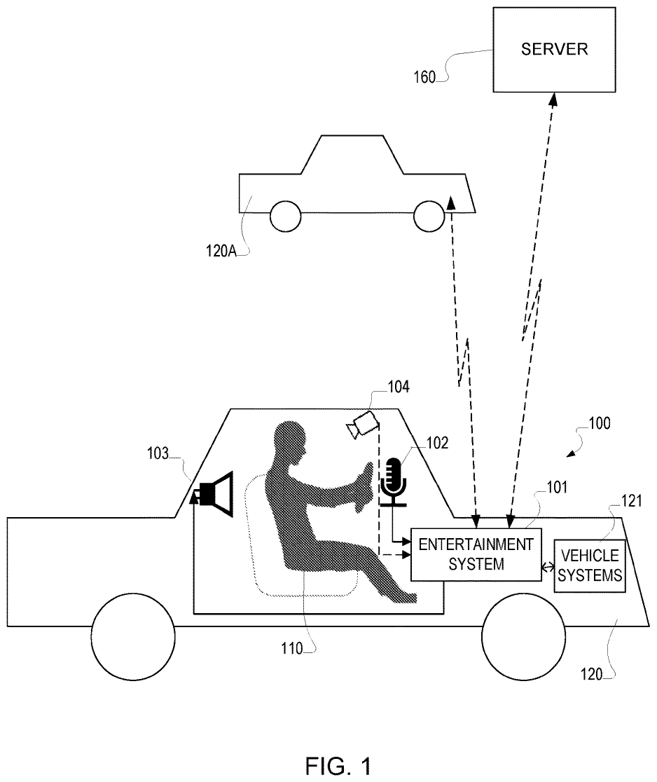

Referring to FIG. 1, an audio processing system 100 provides a way for a user 110 to “sing along” with recorded audio presented in an acoustic environment generally to provide an enjoyable experience for the user or to other listeners of the combination of the user's vocal input and the recorded audio. This process is often referred to as “Karaoke”, and while the term is used to describe this system no inference should be made regarding the characteristics of the system based on the usage of the word. Particular examples of a Karaoke system are described below in the context of the acoustic environment being a vehicle 120 (or multiple vehicles) and the users and/or listeners being drivers and/or passengers in a vehicle.

In the vehicle example illustrated in FIG. 1, the user 110 is a driver of a vehicle in which audio is played via one or more speakers 103 in the vehicle cabin, and audio is captured at one or more microphones 102 in the cabin. While a single microphone is illustrated, multiple microphones for instance forming a directional microphone array may be used. Furthermore, while the figure and discussion focusses on a single user, examples of the system may have multiple users in a vehicle contributing vocal input together. In some examples there are further modes of monitoring the users. One such example is via a camera 104, which may be useful in detecting and analyzing the user's vocal output (e.g., based on lip position etc.) particularly in high noise or high music volume situations. Some examples described below involve users in multiple vehicles, for instance in a first vehicle 120 and a second vehicle 120A, and the processing in the multiple vehicles may be coordinated, for example, to synchronize the input and/or output processing in the multiple vehicles. Finally, the songs that are played as part of this process may be stored local to the vehicle (e.g., in the entertainment system), or may be streamed from a server 160 in communication with the vehicle, or may be streamed (e.g., over a Bluetooth wireless link) from a user's smartphone in the vehicle, for example, being stored on the smartphone, or retrieved (e.g., over a cellular data link) from a remote server by an application executing on the smartphone. In some examples, metadata for the song may be available, for example, including genre, pre-compute acoustic or musical parameters, which may be varying through the song, and lyric text.

In at least some examples, the audio processing described below is performed in an entertainment system 101, which generally includes a general purpose computer processor and/or a digital signal processing (DSP) processor under software control (e.g., with software instructions stored in the entertainment system in a non-transitory machine-readable medium). Not illustrated are user inputs to the entertainment system (e.g., manual, or by voice command), which may be used to initiate the audio processing, select a desired song, adjust volume, and the like. Furthermore, the entertainment system 101 may receive input from vehicle systems 121, for example, providing vehicle state (e.g., speed of the vehicle, navigation state etc.), which may affect the operation of the system. In some example, the audio processing is performed on the same platform as an in-car communication (ICC) system, for example, utilizing the same microphones and speakers that are used to enhance communication between users (e.g., driver and passengers) in a vehicle.

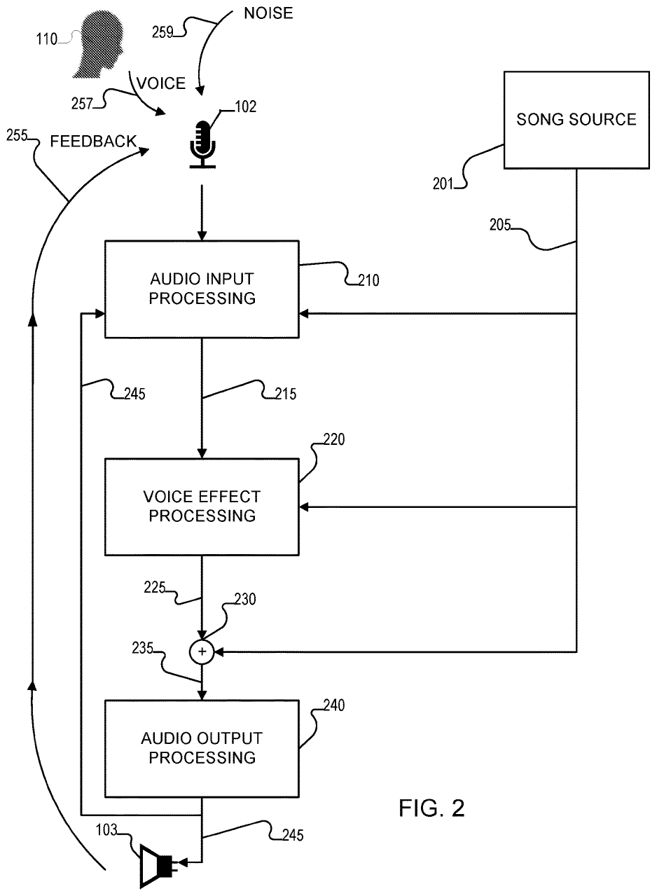

Referring to FIG. 2, audio processing includes audio input processing 210, followed by voice effect processing 220, and then audio output processing 240. The audio input processing receives audio input from the vehicle microphone(s) 102 capturing an acoustic signal in the vehicle cabin. In general, the microphone 102 captures the user's voice 257, noise 259 from the vehicle (e.g., road noise or interfering speech from non-singing individuals or voice assistants), and acoustic feedback 255 from the speaker(s) 103 to the microphone(s) 102. The audio input processing may perform one or both of acoustic “echo” cancellation and noise reduction. The echo cancellation removed as much as possible of signals emitted from the speaker(s). This cancellation may be based on the signal 245, which represents the acoustic signal emitted by the speaker 103, or may be based on the audio signal 205 of the song being played, and may use an adaptive cancellation approach, for example, adapting a cancellation filter (e.g., using a least mean squared (LMS) approach). Various noise reduction approaches may be based, for example, on spectral subtraction or adaptive Wiener filtering. The audio input processing may further include acoustic beamforming or microphone selection to improve the capture of the user's voice and/or exclude interfering noise and/or speaker feedback. The audio input processing may further include automatic gain control and/or equalization, for instance, to match the level of the song 205 or possibly match a target level that is provided with the song representing the level of the excluded original vocals of the song.

The output of audio input processing 210 is an audio vocal signal 215, which ideally represents only the user's voice, and in practice may include residual noise and song signals that have been significantly attenuated. The vocal signal 215 is then processed by a voice effect processing module 220. As discussed further below, this module introduces audio effects to enhance the user's vocal input. The module receives the song signal 205, thereby allowing the effects to be dynamically adjusted to match the song as a whole, and/or to vary during a song, for example, with different effects during a verse and during a chorus. In some examples as described further below, the song signal 205 includes data as well as audio signals, for example, providing metadata that is used for adjusting the voice effects. In some examples, not illustrated in FIG. 2, acoustic conditions such as the noise level or other noise characteristics (e.g., spectral shape) are provided to the voice effect processing module 220, for example, to modify the parameters of certain voice effects, for example, reducing the amount of reverberation in high-noise situations. The output of the module is an enhanced vocal signal 225. In some examples, the voice effect processing is also controlled directly by the user, for example, by setting parameters using manual or voice command inputs.

The enhanced vocal signal 225 is then combined with the song signal 205, illustrated in this example, as a signal summation 230, yielding a combined signal 235, which is passed to an audio output processing module 240. For example, this output processing module may amplify the combined signal to a level controlled by the user and adjust typical parameters such as balance and front-back fade in multiple speaker situations. The output of the audio output processing module 245 is an audio driving signal 245, which drives the speaker(s), and which may be fed back to the audio input processing module 210 for the purpose of “echo” cancellation. In some examples, the audio out processing is adaptive to the environment of the vehicle, for example, increasing overall level compression in high-noise environments.

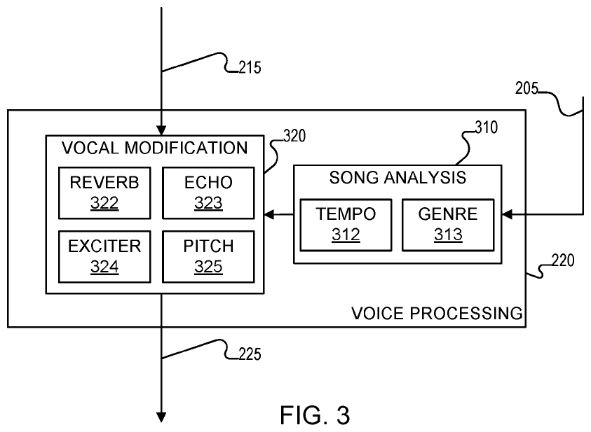

Referring to FIG. 3, in one example of a voice processing module 220, the song signal 205 is first processed by a song analysis module 310, and the analysis information is passed to a voice modification module 320, which processes the voice signal 215 to produce the enhanced voice signal 225. In one example, the song analysis module can provide an on/off indicator of whether a song is being played, or if a song being played is suitable for Karaoke because it is lacking vocals. The song analysis module 310 may make this determination, for instance, based on a spectral signal energy determination, which may distinguish non-song (e.g., voice only) audio from song audio. In another example, the song analysis module may include a broad categorization 313 of the song as a whole, for example, by genre classifying the song a “rock and roll,” “folk,” “a cappella,” etc. The song categorization may also track varying parameters, such as tempo (e.g., beats per minute). Many other parameters may be determined from the acoustic signal and/or provided from metadata provided for the song, such as the level (power, amplitude), musical key, time signature, chorus vs. verse indication, and data regarding the excluded lyrics, such as a representation of the words that are excluded from the song audio signal. The characterization of a song may also be done prior to playing the song. The characterization data may be stored, for example, as meta data with the song signal audio.

The voice modification may implement one or more controllable modifications of the voice signal. Such modifications may include addition of reverberation 322 or echo 323. Such modifications may be parameterized, for example, including characterizations of the echo (e.g., the time delay of the echo) or the reverberation characteristics (e.g., time impulse response). Similarly, an exciter 324 (i.e., for adding harmonic distortions) may be parameterized by its gain, and pitch modification may be parameterized by the target key of the song, for example, as automatically detected in the song audio or as provided in metadata for the song.

Not illustrated in FIG. 3 are alternatives that include modification of the song audio based on the captured voice signal 215. For example, such song modification may include time modification to match the user's singing rate, or selection of portions of a song based on recognition or matching of the sung lyrics to the original song lyrics. Such tracking may be beneficial to the vehicle environment in which a driver may not have the luxury to safely read song lyrics while driving!

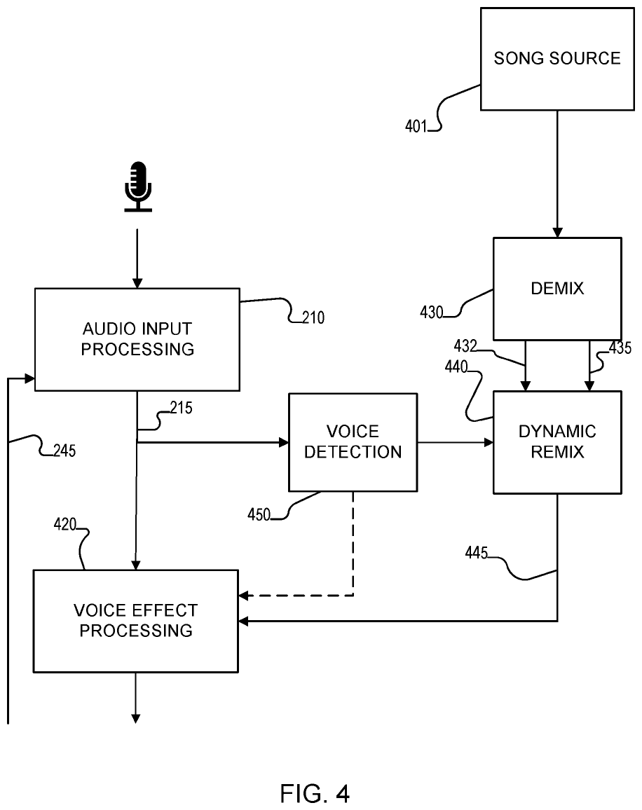

Referring to FIG. 4, in some examples, the system is able to adapt to whether or not the user is singing, thereby providing a Karaoke experience if they are singing, and providing the original audio with vocals if they are not, for example, because they have forgotten the words. In this example, the audio input processing 210 functions as in the example of FIG. 2. The vocal signal 215 (which may or may not in fact include the user's vocals) is passed to a voice detector 450, which determines a voice level, which may represent a binary indicator of whether or not the user is singing, or in some example, the voice level may represent the acoustic volume (e.g., amplitude, energy) of the singing. In some examples, voice is only detected during periods of time when original vocals are present, for example inhibiting user vocals to be introduced at other times. Based on the voice level output of the voice detector 450 a dynamic remixer 440 passes, attenuates, or fully blocks original vocals 435 while passing the vocal-removed song audio 432. In some examples, during periods that the user is singing, the output signal 445 of the remixer 440 corresponds to the song audio 205 of FIG. 3, in some examples including an attenuated version of the original vocals 435 based on a level of the user's signing, and during periods that the user is not singing, then signal 445 corresponds to the original song including its original vocals. In some examples, attenuation of the original vocals is based on the voice level using a history (e.g. a time filtering) of the voice level (whether binary or representing an acoustic volume). In use, for example, when a user forgets the words of the song and stops singing, the original vocals provide an audio cue to the words, and if the user merely starts singing at a lower level because they are unsure of the words, the original vocals are included at an attenuated level. The voice effect processing 420, which is optional in the example illustrated in FIG. 4, can operate in the manner of the voice effect processing 220 of FIGS. 2 and 3, optionally inhibiting processing if the voice detector 450 indicates that the user is not singing. In the example illustrated in FIG. 4, the song source 401 provides the song in audio form with the original vocals, and an automatic demixer 430 separates that audio into the vocals 435 and the remainder of the audio as signal 432 either before or during the playing of the song, such that the combination (e.g., sum) of signals 432 and 435 yields the original song audio. A variety of demixers may be used, for example, as describe in Mitsufuji et al, “Audio Demixing Challenge 2021” arXiv: 2108.13559v3 (2022). Note that various forms of demixing may be used, for example, with multi-part vocals (e.g., a Capella) a particular voice part may be removed while retaining the other voice parts. In some examples, the demixing is performed prior to the playing of the song, for example, to reduce the computation required during the playing of the song. For example, the demixed song may be provided remotely to the vehicle and/or stored in a song library in the vehicle. In some examples, the presence of vocals (e.g., signal energy) in the original vocals 435 is used to determine periods of time when the user is expected to sing, thereby allowing the voice detector 450 to only operate to detect the user's voice during those periods and being the basis for a timeout after absence of the user's voice when the original vocals should be reintroduced. Note that in this document, when referring to combining a first signal with a second signal to produce a third signal, such a combination is not limiting in that yet a fourth signal may be combined with the first and second signals to produce the third signal. Further, the particular order or approach of forming the third signal should not be understood to the limited to a particular sequence of operations, as long as the third signal includes at least some of the other signals that are combined to form it.

As introduced above, in some examples, users in multiple vehicles that are coupled by a mobile communication system (e.g., cellular data) participate in providing vocals for a signal song. In some examples, a user in each car has a cellular smartphone that is coupled to the entertainment system in each vehicle, and inter-vehicle communication is via the smartphones, while in some examples, inter-vehicle mobile communication integrated into the vehicles. There are a number of examples of coordination of the entertainment systems in multiple cars to provide a multicar experience. In one example, the same song is stored at each vehicle and is played in both vehicles in a time-synchronized manner, and vocals are picked up in each vehicle. The local vocals are played out as described above, and are also transmitted to the remote vehicle, where they are combined with the local vocals there. The remote vocals are also received at the local system, and added to the signal that is output in the local vehicle. While exact synchronization is desirable, to the extent that a perfect synchronization cannot be achieved, the mismatch may be considered to be a reverberation effect such that the remote vocals are only heard as delayed reverberation without a direct (i.e., delay-free) component. In some such examples, the voice processing module may be modified to use the remote vocals in addition of such reverberation effects. In some examples, the remote vocals may be provided as background singers, for example, with their contribution being attenuated or spatially placed in the acoustic environment differently than the local vocals.

In some multi-vehicle examples, rather than synchronizing the audio, one vehicle may contribute a subset of vocal parts, with those parts being subsequently presented in another vehicle in which the users there present additional vocal parts. This approach may be accomplished by different vehicles cancelling different of the vocal parts for replacement by the users in those vehicles.

Referring again to FIG. 3, the mapping from the output of song analysis to parameters of vocal modification may be based on various techniques. One technique makes use of predetermined data that has been tuned to different situations. For example, setting of reverberation time and exciter gain may be parameterized by genre of the song as shown in the following table:

Effect Configuration

| | | Reverberation Time | Exciter Gain |
|---|---|---|---|
| Genre | Western | 800 ms | 0 dB |
| | Ballade | 2000 ms | 3 dB |
| | Rock/Pop | 1500 ms | 5 dB |
| | Hip Hop | 500 ms | 2 dB |
| | Hard Rock | 1000 ms | 10 dB |
| | Jazz | 1000 ms | 6 dB |

In some examples, the mapping from a characterization of a song to parameters of the voice modification is a learned mapping, for instance, implemented as a decision tree, neural network, and/or regression model. Such a learned mapping may be based, for example, on training data that includes songs and manual user settings for the songs according to their preference thereby having the automated system essentially mimic a human's choice of settings. In some examples, such a learned mapping may be adapted to the preferences of particular users, for example, based on monitoring the user's modification of automatically set parameters.

As introduced above, the vehicle environment is one example in which the system may be deployed. It is equally possible to use the dynamic adjustment of vocal effects in more conventional environments such as night clubs. Also, multi-location synchronized (or time shifted) implementations may include all or some of the locations being non-vehicle locations.

Implementations of the techniques described above may make use of software, hardware, or a combination of hardware and software. Implementations using software may make use of processor instructions stored on non-transitory machine-readable media, with execution of the instructions by a processor or a processing system causing the methods to be performed. The instructions may include high-level language, intermediate representations (e.g., “bytecode”), or machine-level instructions, and the processor executing the instruction may be a physical processor, or may involve a virtual processor that accepts the instructions and causes a physical processor hosting the virtual processor to perform steps of the methods. A processing system may include components that execute in one or more vehicles (or other user equipment) and may also include remote server (e.g., “cloud”) based processors. A processing system may include special-purpose processors such as digital signal processors (DSPs), for instance, for execution of audio processing functions, and high-performance numerical processor, such as graphics processing units (GPUs) or tensor processors, which may be used for artificial neural network implemented functions such a vocal removal. Hardware implementations may include special-purpose circuitry, for example, to implement audio processing such a echo cancellation or vocal removal.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

1. A method for dynamic audio modification of user input for presentation with playback of a source song, the method comprising:
processing a microphone signal to produce an audio voice signal representing a user input;
determining parameter values for one or more audio modification approaches based on characteristics of the source song;
processing audio voice signal with the audio modification approaches configured according to the determined parameter values to produce an enhanced vocal signal;
combining the enhanced vocal signal and the source song to produce an audio driving signal; and
providing the audio driving signal for acoustic presentation to the user.

2. The method of claim 1, further comprising acquiring an acoustic signal at a microphone to produce the microphone signal, wherein said acoustic signal includes at least the user's voice and the acoustic presentation of the audio driving signal.

3. The method of claim 2, wherein processing the microphone signal includes removing the acoustic presentation of the audio driving signal based on an adaptation that makes use of at least one of a reference of the audio driving signal and source song.

4. The method of claim 2, wherein said acoustic signal include ambient noise, the processing of the microphone signal comprises noise reduction.

5. The method of claim 1, wherein audio modification approaches include one or more of reverberation, echo, excitation, and pitch modification processing.

6. The method of claim 1, wherein characteristics of the source song includes one or more of a genre, tempo, musical key, and time signature.

7. The method of any of claim 1, wherein determining the parameter values includes determining time varying parameter values that vary during a song.

8. The method of claim 1, further comprising:
determining an original vocals signal and a vocal-removed song signal corresponding to an original source song; and
wherein combining the enhanced vocal signal and the source song comprises combining the enhanced vocal signal and the vocal-removed song signal.

9. A method for dynamic audio modification of user input for presentation with playback of a source song, the method comprising:
determining an original vocals signal and a vocal-removed song signal corresponding to an original source song
processing a microphone signal to produce an audio voice signal;
processing the audio voice signal to determine a voice level of a user input, including determining a presence of the user input during a first period and an absence of the user input during a second period;
forming an audio driving signal, including combining the audio voice signal and the vocal-removed song signal to produce an audio driving signal during the first period, and combining the original vocals signal and the vocal-removed song signal to produce the audio driving signal during the second period; and
providing the audio driving signal for acoustic presentation to the user.

10. The method of claim 9, wherein forming the audio driving signal further includes, during the first interval, combining the original vocals signal at an attenuated level that is based on the determined voice level.

11. The method of claim 9, wherein determining the original vocals signal and the vocal-removed song signal includes receiving said vocals signal and said vocal-removed signal prior to the playback of the source song.

12. The method of claim 9, wherein determining the original vocal signal and the vocal-removed song signal includes processing the original source song to demix vocal and vocal-removed components of the original source song.

13. The method of any of claim 9, further comprising detecting voice in the microphone signal, and during a period when voice is not detected in the microphone signal providing a signal corresponding to the original source song, including providing at least some of the original vocals signal, for acoustic presentation to the user.

14. The method of claim 1, wherein the microphone signal is acquired in a cabin of a first vehicle, and the audio driving signal is presented in the cabin of the first vehicle.

15. The method of claim 14, further comprising receiving a remote vocal signal from a second vehicle, and combining the enhanced vocal signal, the remote vocal signal, and the source song to produce the audio driving signal.

16. The method of claim 15, further comprising providing the enhanced vocal signal for presentation in the second vehicle.

17. The method of claim 15, further comprising synchronizing presentation of the song in the first vehicle and the second vehicle.

18. The method of claim 14, wherein determining the parameter values for one or more audio modification approaches based on characteristics of the source song is performed at the first vehicle during presentation of the song to the user.

19. The method of claim 14, wherein determining the parameter values for one or more audio modification approaches based on characteristics of the source song is performed prior to presentation of the song to the user.

20. A non-transitory machine-readable medium comprising instructions stored thereon, the instructions, when executed by a processor, cause the processor to perform steps comprising:
processing a microphone signal to produce an audio voice signal representing a user input;
determining parameter values for one or more audio modification approaches-based on characteristics of a source song;
processing audio voice signal with the audio modification approaches configured according to the determined parameter values to produce an enhanced vocal signal;
combining the enhanced vocal signal and the source song to produce an audio driving signal; and
providing the audio driving signal for acoustic presentation to the user.

21. An audio processing system, comprising a processor configured to perform steps comprising:
processing a microphone signal to produce an audio voice signal representing a user input;
determining parameter values for one or more audio modification approaches-based on characteristics of a source song;
processing audio voice signal with the audio modification approaches configured according to the determined parameter values to produce an enhanced vocal signal;
combining the enhanced vocal signal and the source song to produce an audio driving signal; and
providing the audio driving signal for acoustic presentation to the user.

22. The audio processing system of claim 21, comprising an in-vehicle audio processing system.

23. The audio processing system of claim 21, integrated into at least one of an audio entertainment system, a hand-free telephony system, and a voice assistant system.
